(19) United States
(12) Patent Application Publication
(10) Pub. No.: US 2019/0359189 A1
(43) Pub. Date: Nov. 28, 2019

(54) METHOD FOR MAINTAINING TOTAL BRAKING POWER OF A TRAIN WHILE TAKING THE AVAILABLE FRICTION CONDITIONS INTO CONSIDERATION

(71) Applicant: KNORR-BREMSE SYSTEME FÜR SCHIENENFAHRZEUGE GMBH, Munich (DE)

(72) Inventors: Thomas RASEL, Höhenkirchen-Siegertsbrunn (DE); Ulf FRIESEN, Neubiberg (DE); Christoph TOMBERGER, Munich (DE); Jörg-Johannes WACH, Munich (DE); Reinhold MAYER, Karlsfeld (DE)

(21) Appl. No.: 16/472,655

(22) PCT Filed: Dec. 12, 2017
(86) PCT No.: PCT/EP2017/082362

§ 371 Date: Jun. 21, 2019

(30) Foreign Application Priority Data
Dec. 21, 2016 (DE) 10 2016 125 193.3

(51) Int. Cl. B60T 8/17; B60T 13/66

(52) U.S. Cl. CPC B60T 8/1705; B60T 8/172; B60T 13/665

(57) ABSTRACT

The invention relates to a method for maintaining total braking power of a rail vehicle while taking the available friction conditions into consideration. The method includes recognizing that at least one unit is wheel-slide controlled; retrieving the type of friction prevailing on the wheel-slide controlled units; determining the values μ0 and Kμ0 for each unit that is wheel-slide controlled; forming a function for the value μ0 and a function for the value Kμ0, in each case over the entire length of the units comparing the actual braking request in each of the units, to the function of the value Kμ0, and changing each braking request in each of the units, towards the respective value of the function of Kμ0.

### PRIORITY CLAIM AND CROSS REFERENCE

This patent application is a U.S. National Phase of International Patent Application No. PCT/EP2017/082362 filed Dec. 12, 2017, which claims priority to Germen Patent Application No. German 10 2016 125 193.3 filed Dec. 21, 2016, the disclosures of which are incorporated herein by reference in their entirety.

### FIELD

Disclosed embodiments relate to operations to accelerate or brake a rail vehicle, wherein acceleration (traction) or braking forces must be transmitted at the contact point between wheel and rail.

### BACKGROUND

The maximum force which can be transmitted at the contact point between wheel and rail depends substantially on the friction conditions between wheel and rail. On a dry rail, larger forces can be transmitted than on a wet or slippery rail. If during the braking of a rail vehicle a larger braking force is requested than can be transmitted on account of the friction conditions between wheel and rail, at least one of the wheels may become locked and slip along the rail. This condition is known as sliding. If, by contrast, during the accelerating of a rail vehicle a greater acceleration (traction) is requested than can be transmitted on account of the friction conditions between wheel and rail, at least one of the wheels may spin. This condition is known as skidding. In other words, skidding describes a condition in which the wheel's circumferential velocity is greater than the speed of travel. Similarly, sliding describes a condition in which the wheel's circumferential velocity is less than the speed of travel. If the wheel's circumferential velocity and the speed of travel are identical, this condition is known as rolling.

In general, the occurrence of a relative movement between wheel circumference and rail is known as slip. Thus, when the wheel's circumferential velocity and the speed of travel are not identical, slip will consequently occur. Slip is furthermore necessary to even transmit traction or braking forces between rail and wheel. When a slip of zero is present on a wheel, this means that this wheel is rolling freely, i.e., no torques are acting on the wheel. Consequently, without slip no power transmission is possible, i.e., no transmission of traction or braking forces between wheel and rail. When the slip is very large, for example during sliding or spinning, it might not be possible to transmit any large forces between wheel and rail. Consequently, the optimal slip for the transmission of maximum traction or braking forces lies between zero (rolling condition) and a very large value, such as 100 percent (sliding or spinning condition).

### SUMMARY

Disclosed embodiments provide a method for maintaining the total braking power of a rail vehicle while taking the available friction conditions into consideration, a device, and a usage thereof, to brake a rail vehicle with a required deceleration, even though limit friction conditions are present at the contact point between wheel and rail.

### BRIEF DESCRIPTION OF THE FIGURES

FIG. 1 shows two diagrams (friction or adhesion vs. slip) with different types of friction.

FIG. 2 shows at the top a rail vehicle with three cars, namely, one car on the far left, one car in the middle, and one car on the far right, in a schematic side view.

FIG. 3 shows the exemplary embodiment of FIG. 2, however in the condition shown in FIG. 3 the type of friction nH has been ascertained at the only sliding unit I.

FIG. 4 shows a further exemplary embodiment in which the graphs for Kμ0 and μ0 are not constant, but rather have a linear trend (by a function of first degree).

FIG. 5 shows a further exemplary embodiment in which the graphs for Kμ0 and μ0 are neither constant nor linear, but instead vary according to a function of at least second degree.

### DETAILED DESCRIPTION

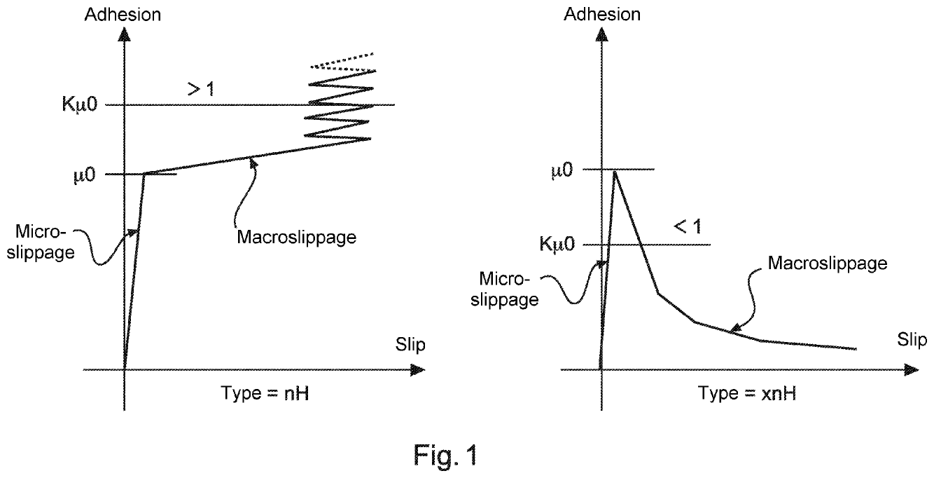

Optimal slip is dependent on the friction conditions or the friction state between wheel and rail. The optimal slip on wet rails may accordingly be different than on dry rails. Different friction conditions between wheel and rail are called hereinafter the types of friction. Different types of friction are illustrated as examples in FIG. 1.

FIG. 1 shows two diagrams (friction or adhesion vs. slip) with different types of friction. The diagram on the left shows a type of friction known in technical circles as nH (low adhesion value), while the type of friction shown on the right is known as xnH (extremely low adhesion value). The slip is plotted in each case on the (horizontal) x-axis of the diagram, while the (vertical) y-axis shows the adhesion or the friction force or its coefficient of friction proportional to this and transmissible between the wheel and the rail. Furthermore, the diagrams show a value μ0, which lies at the transition point from microslippage to macroslippage. The portion of the graph at the left of μ0 shows in each case the region of microslippage, and the portion of the graph at the right of μ0 shows in each case the region of macroslippage. Furthermore, μ0 is basically defined by the maximum friction value in the region of microslippage (left part of the graph).

In the case of the type of friction nH shown on the left, maximum forces can be transmitted in the region of macroslippage, while in the type of friction xnH shown on the right the maximum forces can be transmitted in the region of μ0. If, for example an nH friction condition is present (left diagram in FIG. 1), additional braking force can be applied starting from μ0, which is implemented in the macroslippage region, since the graph continues to rise starting from μ0. This behavior is also known as “self improvement”. If, on the other hand, xnH friction conditions are present, the braking force can only be increased in a region between 0 and μ0 to a maximum determined fraction of μ0 to prevent a transition to the macroslippage region (because here the graph again decreases, starting from μ0, and no “self improvement” occurs). This maximum fraction of μ0 to be determined is denoted in the diagrams as Kμ0 and is referred to μ0. Consequently, the value Kμ0 represents a factor which is referenced to μ0 and indicates a percentage fraction of μ0 which can be used for the force transmission without having to fear a transition to the macroslippage region for a type of friction xnH. For the type of friction nH (left diagram in FIG. 1), one obtains Kμ0>1, whereas for the type of friction xnH (right diagram in FIG. 1) one obtains Kμ0>1. For example, in a type of friction xnH, if 80% (=0.8) of μ0 needs to be usable during the braking to ensure a 20% “safety margin” for the macroslippage region, one obtains a Kμ0 of 0.8.

In the prior art, methods and devices are known for redistributing of braking forces between individual cars and/or axles of a rail vehicle if a requested braking force cannot be implemented on account of a local restriction at one of the braked cars and/or axles. Such a local restriction might be due, for example, to one of the braking disks being vitrified, or the requested brake application force cannot be applied for various reasons, or the brake linings were not properly adjusted. In such a case, it is known in the prior art how to redistribute the braking forces in static manner

But if a braked wheel (or a braked axle, or a braked car) cannot apply the requested braking force because of the friction conditions between wheel and rail, no method is known for a targeted redistribution of the braking forces. Disclosed embodiments solve this problem by providing a method for maintaining the total braking power of a rail vehicle while taking the available friction conditions into consideration, a device, and a usage thereof, to brake a rail vehicle with a required deceleration, even though limit friction conditions are present at the contact point between wheel and rail.

In the following, the term units shall be used. By a unit may be meant a wheel, an axle, several axles, a bogie, a car, or several cars. Furthermore, in the following a condition is described in which the wheel slide protection system is active in a unit, or a unit is wheel-slide-controlled. This means that in this unit the condition of sliding has been recognized, and thereupon the braking force at this unit is reduced to prevent the sliding at this unit. In the figures, furthermore, the abbreviation WSP is used, which stands for “Wheel Slide Protection”. The WSP system, hereinafter called only WSP, recognizes the condition of sliding at a unit and thereupon reduces the braking forces acting on this unit to limit the slip and thereby furthermore prevent the condition of sliding or locked wheels at this unit. Similar to the mode of operation of the WSP is the antilock system (ABS) known in road vehicles.

Furthermore the functions mentioned in the claims shall be designated as graphs hereafter and be represented as such in the figures, to be able to graphically describe the method claimed. According to the disclosed embodiments, however, the functions needs not be represented as graphs, and instead the method may be implemented based on mathematical computations without a graphical representation.

Based on the above explanations, sliding occurs basically in the region of macroslippage. When sliding occurs at a unit, and this sliding is recognized by the WSP, the WSP furthermore determines which type of friction is present at this unit (nH or xnH, see FIG. 1).

When in the following it is stated that the WSP is active at a unit, this means that the WSP has recognized at this unit the condition of sliding, and thereupon reduces the braking force at this unit to limit the sliding.

Furthermore, the term total braking power shall be used in the following. To bring a rail vehicle to a standstill up to a given stopping point, or to achieve a particular reduced speed at a given track point, the rail vehicle must be braked by an overall or total braking power. From this total braking power, the requested individual braking forces (braking requests or braking force requests) of the individual units are obtained. The total of the individual braking force requests of all the units yields the overall or total braking power.

Disclosed embodiments enable preventing decreasing of the total braking power of all the units caused by inadequate adhesion or friction conditions between rail and wheel by temporary supplementing of braking forces on units which are not wheel-slide-controlled up to that time. As compared to the prior art, additional total braking power potentially present in this condition is made available, and at the same time a decreasing of the total braking power due to inadequate adhesion or friction conditions between rail and wheel is prevented.

In one exemplary embodiment, the mean value of μ0 and Kμ0 is formed for all wheel-slide-controlled axles. Based on the formed mean values of μ0 and Kμ0, a constant graph for μ0 and Kμ0 is formed in each case, containing in each case the formed mean value. Consequently, it can be determined for each not yet wheel-slide-controlled unit whether and if so how much additional braking force can be implemented. These units thereupon provide the additional braking force as a supplement. The forming/computing of the graphs (for the values of μ0 and Kμ0) as constant running graphs is advantageous, since only slight computing power is required for this, and thus the curves of the graphs are more quickly available. Consequently, an extremely short response time can be achieved in the feedback control system.

In a further exemplary embodiment, the graphs for μ0 and Kμ0 are formed as a function of first degree, i.e., a linear curve. The forming/computing of the graphs (for the values of μ0 and Kμ0) as a function of first degree is advantageous, since only a slightly higher computing power is required than for a constant curve, while changing friction conditions between wheel and rail can be better factored in over the entire length of the rail vehicle (greater granularity). Consequently, the regulating of the individual braking forces at the individual units can occur more precisely.

In a further exemplary embodiment, the graphs for μ0 and Kμ0 are formed as a function of at least second degree. Similar to the preceding remarks, while this requires a higher computing power, an even more accurate curve of the graph is achieved, making possible an even more precise regulating of the individual braking forces at the individual units.

A more precise regulating means that the individual braking forces are brought closer to their maximum braking potential, so that the total braking power of the overall rail vehicle is increased.

In a further exemplary embodiment, further external factors of influence go into the computing/determining of the graphs for μ0 and Kμ0, such as the position of the rail vehicle, the weather, the moisture, the velocity or direction of travel of the rail vehicle. In this way, factors of influence which are known ahead of time can be considered in anticipation of a changing of the curve of the graphs for μ0 and Kμ0. This is done similar to a feedforward control known in control engineering.

If a dynamic supplementing of the total braking power by an increasing of the individual braking forces of the individual units at a current moment of time is not possible, in addition to the aforementioned method the lost stopping distance (the braking force vs. time and velocity) within the braking process can be supplemented afterwards according to the disclosed embodiments by an increasing of the total brake force request (the sum of the brake force request of all the units). The lost distance is determined on the basis of the total braking power taking into account the velocity and weight of the vehicle, and it determines the calculation of the supplemental braking request. This is done in an iteration process, until the lost stopping distance is compensated.

In accordance with disclosed embodiments, an adapting of the individual braking requests toward the respective value of the function of Kμ0 can be done both by an increasing and a decreasing of the individual braking requests. In this way, an optimal braking force can be achieved at each unit.

Alternatively, the individual braking requests can only be changed if they are increased by the method according to the disclosed embodiments. This ensures that the individual braking requests are in no way decreased. Such a design simplifies the integration of the method according to the disclosed embodiments in a brake regulating system, since general legal and especially permitting challenges might result if the method of the disclosed embodiments or the device of the disclosed embodiments is also designed to be able to decrease individual braking requests.

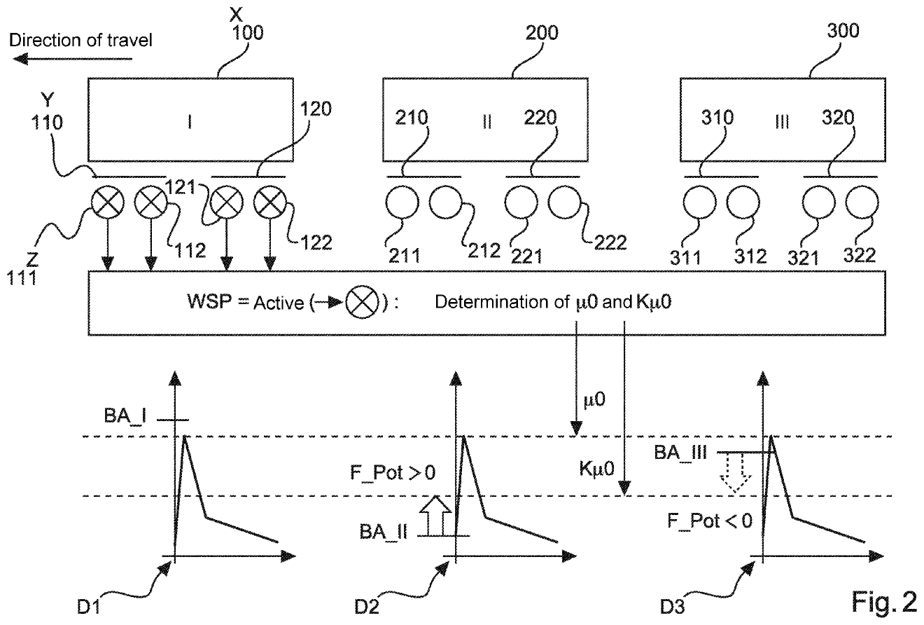

FIG. 2 shows at the top a rail vehicle with three cars, namely, one car on the far left, one car in the middle, and one car on the far right, in a schematic side view. In this exemplary embodiment, a travel direction of the rail vehicle to the left is assumed. In this exemplary embodiment, furthermore, each car corresponds to a unit. Consequently, the left car corresponds to a unit I, the middle car to a unit II, and the right car to a unit III. Each car I, II, III has a superstructure X00 (X=1, 2, 3), represented as a rectangle, and beneath each of these superstructures are arranged two bogies XY0 (Y=1, 2) each, as well as two axles XYZ (Z=1, 2) per bogie Y, of which one wheel is visible in each case in the side view. The variable X here denotes the car (first, second or third, or I, II or III), the digit Y denotes the bogie (first or second bogie of the car X), and Z the axle (first or second axle of the bogie Y). The wheels of the axles XYZ here are represented as circles, and the bogies XYO as horizontal lines above the wheels and the axles XYZ.

For unit/car I, the axles 111, 112 are mounted on the bogie 110, and the axles 121, 122 on the bogie 120. The bogies 110, 120 are furthermore mounted on the superstructure 100. The configuration of the other units/cars II, III is analogous to this. In the exemplary embodiment shown here, unit I comprises the superstructure 100, the bogies 110, 120, and the axles 111, 112, 121, 122. In another exemplary embodiment, not shown, a unit corresponds in each case to one bogie with the axles mounted on it. In a further exemplary embodiment, not shown, a unit corresponds in each case to one axle. In a further exemplary embodiment, not shown, each car has any given number of bogies with any given number of axles mounted thereon.

The coordinating of the individual components with the units may be established according to the requirements. If a heightened regulating precision is desired, a unit may comprise one axle in each case. To decrease the granularity and thus also the computing expense in the regulating process, a unit may comprise one car in each case. To achieve a compromise between regulating precision and computing expense, a unit may comprise a bogie in each case. To achieve further benefits, moreover, this coordination may vary along the overall rail vehicle. For example, one unit may comprise only one axle and/or one bogie, while another unit may comprise an entire car. These coordinations of the individual components with the units may be unchanged over time, or also time variable.

As already mentioned, in FIG. 2 each unit I, II, III comprises one car. The wheels of the unit I are marked by a cross, but the wheels of the cars of units II and III are not. A wheel marked with a cross means that the corresponding axle is currently wheel-slide-controlled, and consequently that sliding is present on this axle, i.e., the axle is currently sliding along the rails. Since the unit I comprises the entire first car, i.e., also all axles 111, 112, 121, 122, only a sliding at the entire unit I can be recognized, i.e., at all the aforementioned axles. If each unit were coordinated with only one axle, sliding could be recognized independently at each individual axle.

Consequently, sliding is recognized at the first unit I in FIG. 2. The other units II, III are at present not wheel-slide-controlled on account of a low brake force request, and consequently no sliding was recognized at their axles. The wheels of the units II, III are therefore not marked with a cross. Now, the prevailing type of friction is determined at the only wheel-slide-controlled unit I, and this corresponds in FIG. 2 to the type of friction xnH. Furthermore, the values μ0 and Kμ0 are determined. These steps are represented roughly in the middle of the vertical arrangement in FIG. 2. After this, a graph is formed for the value μ0 and a graph for the value Kμ0. These graphs in the present representation correspond to a (horizontal) constant. The curves of the graphs are represented by a dashed line. In the type of friction xnH, the graph for the value μ0 is above the graph for the value Kμ0. The value Kμ0, as already mentioned above, corresponds to the portion of the available frictional force (the adhesion potential) which can be used for a braking. Now, for each unit II, III there is assumed an identical type of friction xnH (in this exemplary embodiment), based on the data of the single wheel-slide-controlled unit I, having an identical curve of the friction vs. slip diagram D1, D2, D3. Consequently, the identical value for μ0 and Kμ0 is assumed for the units II, III as was determined for the unit I, because μ0 and Kμ0 can be determined for a unit I, II, III especially when it is currently wheel-slide-controlled.

Now, as already mentioned, there is a constant curve of the graphs from the μ0 and Kμ0 determined at unit I, so that an identical μ0 and Kμ0 results for the units II and III. Consequently, for each unit I, II, III there results an identical friction vs. slip diagram D1, D2, D3. Furthermore, in these friction vs. slip diagrams D1, D2, D3 for each of the units I, II, III the currently demanded braking request BA_I, BA_II, BA_III is 7marked along the (vertical) friction axis. For the unit I, the currently demanded braking request BA_I lies above the value μ0. In retrospect, this is also the reason why the unit I is sliding, because a higher braking request BA_I is demanded than the friction value μ0 allows.

According to this first embodiment, now, the braking request BA_I of the unit I is decreased to the value Kμ0, and furthermore according to the disclosed embodiments the braking requests BA_II of the unit II and the braking request BA_III of the unit III are also regulated to the value Kμ0, without any sliding occurring at the units II, III. The current braking request BA_II of the unit II is below Kμ0 and consequently it will be increased (a braking force potential F_Pot>0 is present). The current braking request BA_III of the unit III is above Kμ0 and consequently it will be decreased (a braking force potential F_Pot<0 is present). Hence, the optimal adhesion potential at all units is utilized. The unit II can brake more heavily (upward arrow at BA_II), without getting into the sliding condition. For the unit III, on the other hand, braking force is reduced (downward arrow at BA_III), to avert the danger of sliding.

According to a second embodiment, not shown, basically no reducing of the braking forces is done. The braking request BA_I of the unit I and the braking request BA_III of the unit III are consequently not decreased to the value Kμ0. However, the braking requests BA_II of the unit II is regulated to the value Kμ0, i.e., increased according to the disclosed embodiments, since a braking force potential F_Pot 22 0 is present. Hence, the optimal adhesion potential is utilized at all units, under the proviso that the braking request is not decreased at any of the units I, II, III.

According to a third embodiment, not shown, a reducing of the braking forces or the braking requests BA_I, BA_II, BA_III is only done optionally. According to this third embodiment, a presetting or a selection is possible as to whether a method according to the first embodiment above or according to the second embodiment above will be carried out.

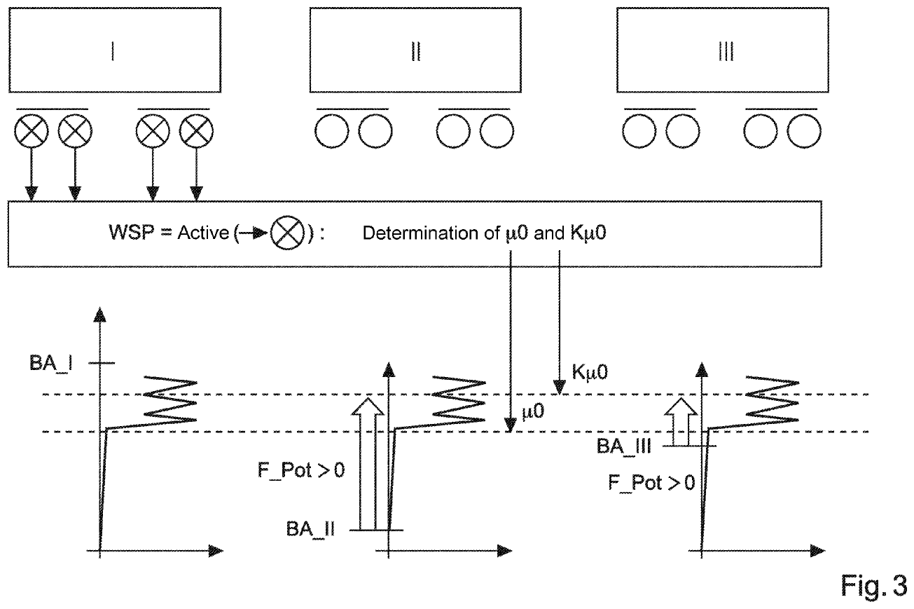

FIG. 3 shows the exemplary embodiment of FIG. 2, however in the condition shown in FIG. 3 the type of friction nH has been ascertained at the only sliding unit I. Consequently, in this condition the value Kμ0 lies above the value μ0. Both the current braking request BA_II of the unit II and the current braking request BA_III of the unit III lies below Kμ0 here, so that for both units II, III the current braking force can be increased (F_Pot>0, upward arrows at BA_II and BA_III).

If in the exemplary embodiment shown in FIG. 2 and FIG. 3 sliding has been recognized at several units I, II, III, then the mean value of the values for μ0 as detected at the sliding units will be formed to determine the (constant) graphs for Kμ0 and μ0, and from this the constant graph for μ0 and for Kμ0 is calculated. In a further exemplary embodiment, shown hereafter, only one constant graph is formed for Kμ0 and μ0 if sliding is recognized at only one of the units I, II, III. If sliding is recognized at several units I, II, III, then a graph will be formed for Kμ0 and μ0, as described below.

The designations of the individual components and the coordination of the components with the units I, II, III remain unchanged in the following described exemplary embodiments.

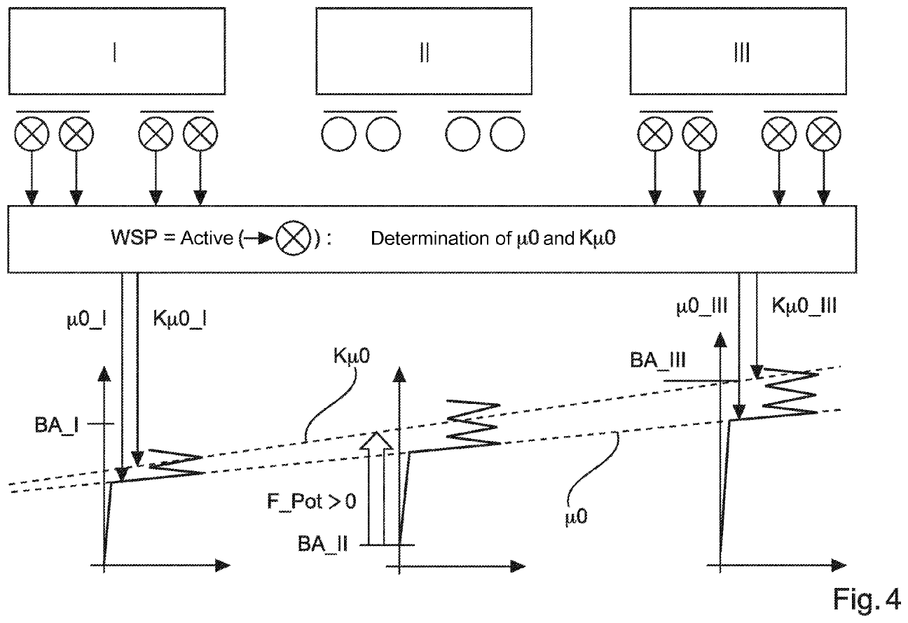

FIG. 4 shows a further exemplary embodiment in which the graphs for Kμ0 and μ0 are not constant, but rather have a linear trend (by a function of first degree). In the condition shown, sliding is recognized at the units I and III (wheels marked with a cross at units I and III), consequently the current type of friction (here, nH) can be determined at the units I, III, as well as the values μ0_I and Kμ0_I for unit I and μ0_III and Kμ0_III for unit III. From these values, now, a linear trending graph can be formed for μ0, containing the values μ0_I and μ0_III. Moreover, a linear trending graph is formed for Kμ0, containing the values Kμ0_I and Kμ0_III. The current braking request BA_II of the unit II lies here below the value Kμ0 at the location of unit II (intersection of the graph of Kμ0 with the y-axis of unit II), so that the braking request BA_II of unit II is increased up to the value of Kμ0 at this place (upward arrow at BA_II), to utilize the available adhesion potential.

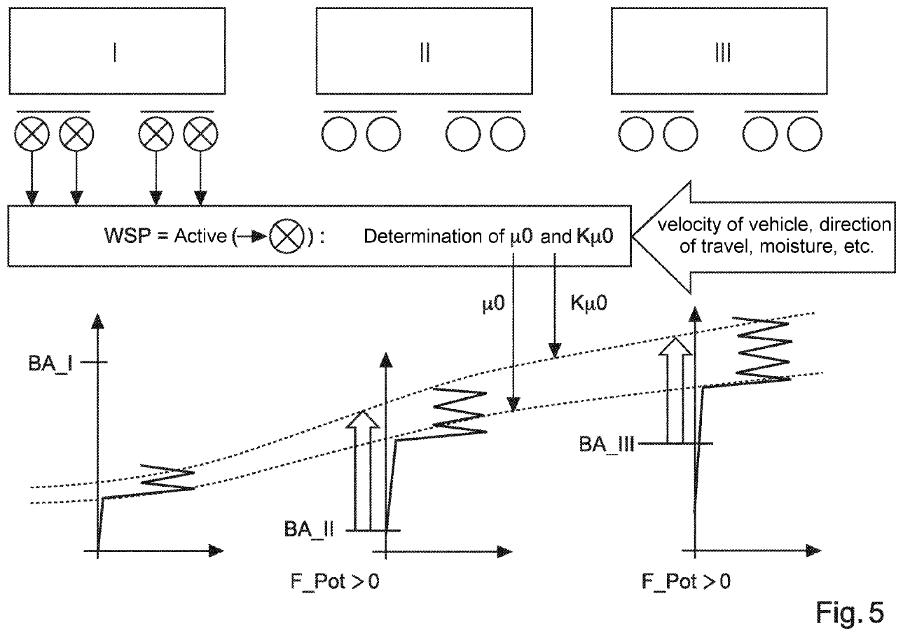

FIG. 5 shows a further exemplary embodiment in which the graphs for Kμ0 and μ0 are neither constant nor linear, but instead vary according to a function of at least second degree. The further configuration of this exemplary embodiment is identical to the previously described exemplary embodiments, especially also the coordination of the components with the units I, II, III. Sliding is recognized in the illustrated condition at unit I (see the wheels of unit I marked with a cross), and so the current type of friction (here, nH) can be determined at unit I, as well as the values μ0 and Kμ0 for unit I. However, for the computation of the curve of the graph of the values μ0 and Kμ0 in this exemplary embodiment, still further factors of influence are called upon, such as the vehicle velocity V_Fzg, and/or the direction of travel, and/or the current humidity, and/or the current moisture on the rails and/or the outdoor temperature and/or special vehicle properties (e.g., weight, axle spacings), and so forth. By bringing in these further factors of influence and the computational mode used, one obtains a curve of the graphs for μ0 and Kμ0 which is neither constant nor linear, but instead follows a function of at least second degree. It is determined that the braking requests BA_II and BA_III at the units II and III lie below the respective values of Kμ0. Consequently, the braking requests BA_II and BA_III at the units II and III are increased to the respective value of the graph of Kμ0 (upward arrow at BA_II and B A_III).

In another exemplary embodiment, not shown, the curves of the graphs for μ0 and Kμ0 have a constant or linear trend, even though other factors of influence, as mentioned above, are brought into the calculation of the curve of the graphs.

In a further exemplary embodiment, not shown, the graphs for μ0 and Kμ0 are determined at a time when none of the units is sliding in the macroslippage region. The curves of the graphs here are determined by measurements, based on one or more gradient determination(s) of adhesion vs. slip with subsequent evaluation, for example, from a memorized family of characteristic curves.

### LIST OF REFERENCE SYMBOLS

nH Type of friction “low adhesion value”
xnH Type of friction “extremely low adhesion value”
μ0 Transition point from micro- to macroslippage
WSP Wheel Slide Protection
I, II, III Units
X00 Layout of unit X
100 Layout of unit I (the first unit)
XY0 Bogie Y of unit X
110 Bogie 1 of unit 1 (I)
XYZ Axle Z of bogie Y of unit X
321 Axle 1 of bogie 2 of unit 3 (III)
D1 Friction vs. slip diagram for unit 1 (I)
D2 Friction vs. slip diagram for unit 2 (II)
D3 Friction vs. slip diagram for unit 3 (III)

1. A method for maintaining the total braking power of a rail vehicle while taking the available friction conditions into consideration, the method comprising:
recognizing that at least one unit is wheel-slide-controlled;
retrieving a type of friction prevailing on the wheel-slide-controlled units;
determining the values μ0 and Kμ0 for each unit that is wheel-slide-controlled;
forming a function for the value μ0 and a function for the value Kμ0, in each case over the entire length of the units in the longitudinal direction of a rail vehicle based on the determined values of μ0 and Kμ0 of the wheel-slide-controlled units;
comparing a current braking request at each of the units including the units that are not wheel-slide-controlled, to the value of the function of Kμ0 at the site of the respective braking request;
changing each braking request at each of the units including the units that are not wheel-slide-controlled, toward the respective value of the function of Kμ0 at the site of the respective braking request.

2. The method of claim 1, wherein the changing of each braking request toward the respective value of the function of Kμ0 is done only for such braking requests that are increased thereby.

3. The method of claim 1, wherein both the function for the value μ0 and the function for the value Kμ0 are in each case constant, formed by the mean value of the respective values of μ0 and Kμ0 at the wheel-slide-controlled units.

4. The method of claim 1, wherein both the function for the value μ0 and the function for the value Kμ0 is linear, formed by the respective values of μ0 and Kμ0 of two wheel-slide-controlled units.

5. The method of claim 1, wherein both the function for the value μ0 and the function for the value Kμ0 is a function of at least second degree, formed by the respective values of μ0 and Kμ0 of several wheel-slide-controlled units.

6. The method of claim 1, wherein at least one of the functions of the values for μ0 and Kμ0 is adapted based on further factors of influence including at least one of position of the rail vehicle, weather, moisture, velocity, outdoor temperature, weight of the vehicle, axle spacings, or direction of travel.

7. A method for maintaining the total braking power of a rail vehicle while taking the available friction conditions into consideration, the method comprising:
ascertaining of a function for the values μ0 and Kμ0 based on one or more gradient determinations of friction vs. slip at least at one of the units with subsequent evaluation, without one of the units being wheel-slide-controlled;
comparing the current braking request at each of the units to the function of the value Kμ0 at the site of the respective braking request;
changing each braking request at each of the units toward the respective value of the function of Kμ0 at the site of the respective braking request.

8. The method of claim 7, wherein the changing of each braking request toward the respective value of the function of Kμ0 is done only for such braking requests that are increased thereby.

9. The method of claim 7, further comprising:
determining that an equalizing of a requested total braking power of all units is not possible due to temporarily inadequate adhesion or friction conditions between the wheel and the rail; and
increasing of the requested total braking power of all units, so that a compensating of a lost stopping distance is possible at a later time when the adhesion and friction conditions are suitable for this.

10. A device for implementing a method for maintaining the total braking power of a rail vehicle while taking the available friction conditions into consideration, the method comprising:
recognizing that at least one unit is wheel-slide-controlled;
retrieving a type of friction prevailing on the wheel-slide-controlled units;
determining the values μ0 and Kμ0 for each unit that is wheel-slide-controlled;
forming a function for the value μ0 and a function for the value Kμ0, in each case over the entire length of the units in the longitudinal direction of a rail vehicle based on the determined values of μ0 and Kμ0 of the wheel-slide-controlled units;
comparing a current braking request at each of the units including the units that are not wheel-slide-controlled, to the value of the function of Kμ0 at the site of the respective braking request;
changing each braking request at each of the units including the units that are not wheel-slide-controlled, toward the respective value of the function of Kμ0 at the site of the respective braking request

11. (canceled)

12. The method of claim 1, further comprising:
determining that an equalizing of a requested total braking power of all units is not possible-due to temporarily inadequate adhesion or friction conditions between the wheel and the rail;
increasing of the requested total braking power of all units, so that a compensating of a lost stopping distance is possible at a later time when the adhesion and friction conditions are suitable for this.
